(19) United States
(12) Patent Application Publication
(10) Pub. No.: US 2025/0000106 A1
(43) Pub. Date: Jan. 2, 2025

(54) APPARATUS AND METHOD FOR CONTROLLING POSITIONS OF DEBONING ROBOT

(71) Applicant: HOLY COW CO., LTD., Gyeonggi-do (KR)

(72) Inventors: Seung Young KIM, Gyeonggi-do (KR); Byung Hong CHOE, Gyeonggi-do (KR)

(21) Appl. No.: 18/884,126

(22) Filed: Sep. 13, 2024

Related U.S. Application Data
(63) Continuation of application No. PCT/KR2022/021507, filed on Dec. 28, 2022.

(30) Foreign Application Priority Data
Mar. 17, 2022 (KR) 10-2022-0033123

(51) Int. Cl. A22C 17/00; B25J 9/16; B25J 13/08

(52) U.S. Cl. CPC A22C 17/004; B25J 9/1633; B25J 9/1697; B25J 13/085

(57) ABSTRACT

A position control device for a deboning robot is provided. The position control device for the deboning robot may include a first sensor configured to acquire image data including the area where the cutting part of the deboning robot is in contact with a section of the target meat, a controller configured to set a candidate path corresponding to a designated area of the target meat using the acquired image data, and a second sensor configured to measure the magnitude of the force opposing the angle at which the cutting part of the deboning robot is inserted into a section of the target meat from each joint of the deboning robot.

### CROSS-REFERENCE TO RELATED APPLICATION

This application is a U.S. Bypass Continuation Application of International Application No. PCT/KR2022/021507, filed Dec. 28, 2022, which claims priority to and the benefit of Korean Patent Application No. 10-2022-0033123, filed Mar. 17, 2022, the disclosure of which is incorporated herein by reference in its entirety.

### BACKGROUND

### Technical Field

The following description pertains to a position control device and method for a deboning robot. More specifically, it involves using matrix operations of measured reaction forces or torques from contact with a designated part of the target meat to determine if the contacted part is bone, and, based on the determination, reconfiguring the bypass route of the deboning robot.

### Related Art

In 2021, the Ministry of Agriculture, Food and Rural Affairs of South Korea announced a plan to invest 4.2 billion won in carcass deboning process robot technology as a research project under the high-value-added food technology development initiative. The deboning work, which processes the meat from slaughtered cattle and pigs into consumable parts for consumers, relies on skilled professionals. However, the industry faces challenges in recruiting new workers due to sanitary and work environment issues, leading to an aging workforce. The recent COVID-19 pandemic has further complicated the employment of foreign labor, exacerbating the labor shortage in the industry.

### SUMMARY

### Technical Solution

According to one aspect, a position control device for a deboning robot is provided. The device includes a first sensor that acquires image data of the area contacted by the cutter of the deboning robot on a cross-section of the target meat, a controller that sets a candidate path corresponding to a designated part of the target meat using the acquired image data, and a second sensor that measures the magnitude of the force opposing the angle at which the cutter is inserted into the cross-section of the target meat from each joint of the robot.

In one embodiment, the controller can modify the candidate path by comparing the magnitude of the force opposing the insertion angle with a predefined threshold.

In another embodiment, the position control device of the deboning robot may also include a position calculator that calculates multiple position vectors based on the displacement between the position of the cutter and the positions of each joint.

In yet another embodiment, the second sensor can calculate the magnitude of the force opposing the insertion angle into the cross-section of the target meat based on the torques measured at each joint and the position vectors, by performing calculations corresponding to a predefined motion equation.

In a further embodiment, if the magnitude of the force opposing the insertion angle exceeds the predefined threshold, the controller can identify the contacted area as bone and establish a new bypass route corresponding to the designated part of the target meat.

In an additional embodiment, the controller determines a predefined bypass radius corresponding to the designated part of the target meat and modifies the candidate path so that the cutter avoids moving around the bone location within the bypass radius.

In yet another embodiment, the controller can modify the candidate path to allow the cutter to avoid movement according to a bypass radius set in correspondence with the average size of the bones present in the designated part of the target meat.

### BRIEF DESCRIPTION OF THE DRAWINGS

FIG. 1 is an illustration explaining the position control process of the deboning robot.

FIG. 2 is a block diagram for explaining the position control device of the deboning robot.

FIG. 3 is an illustration showing the candidate paths for the movement of the deboning robot set according to the divided meat parts of a cow.

FIG. 4 is a flowchart describing the process of adjusting the candidate path by calculating the reaction force from the designated part of the target meat using the position control device of the deboning robot.

FIG. 5 is an illustration explaining the process of the deboning robot's position control device performing avoidance movements according to the bypass radius.

### DETAILED DESCRIPTION

The specific structural or functional descriptions of the embodiments are disclosed for illustrative purposes only and can be implemented in various forms. Therefore, the embodiments are not limited to specific disclosure forms, and the scope of this specification includes changes, equivalents, or substitutes included in the technical idea.

Terms such as “first” or “second” may be used to describe various components, but these terms should be interpreted solely to distinguish one component from another. For example, a first component may be named as a second component, and similarly, a second component may also be named as a first component.

When it is mentioned that one component is “connected” to another, it can be directly connected or may be connected through another component in between.

Unless contextually indicated otherwise, singular expressions include plural expressions. In this specification, terms like “comprise” or “have” are intended to indicate the presence of stated features, numbers, steps, operations, components, parts, or combinations thereof, without excluding the presence or additional possibility of one or more other features, numbers, steps, operations, components, parts, or combinations thereof.

Unless defined otherwise, all terms used herein, including technical or scientific terms, have the same meaning as commonly understood by one of ordinary skill in the art to which this invention belongs. Terms defined in commonly used dictionaries should be interpreted as having meanings consistent with their meanings in the context of the relevant technology, unless explicitly defined otherwise in this specification.

The embodiments are described in detail below with reference to the attached drawings. In explaining with reference to the attached drawings, the same components are given the same reference numerals regardless of drawing numbers, and redundant descriptions thereof will be omitted.

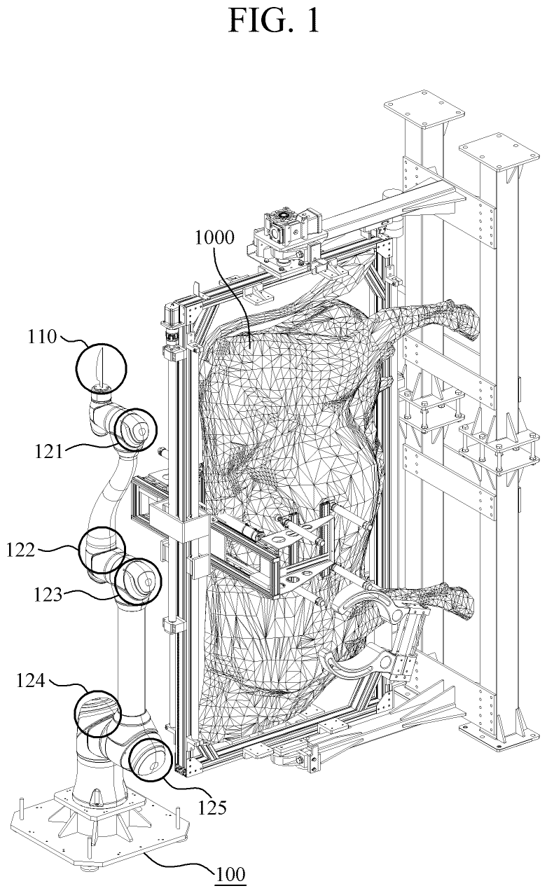

FIG. 1 is an illustration explaining the position control process of the deboning robot. Referring to FIG. 1, a deboning robot 100 that processes the target meat 1000 into consumable parts is shown. The deboning robot 100 includes a cutting part 110 and multiple joints 121, 122, 123, 124, 125 for cutting and deboning. The cutting part 110 is connected to one end of the deboning robot and may include a cutting blade for cutting the target meat 1000. The cutting part 110 is connected to the other end by a swivelable first joint 121 and can be controlled to be inserted into the target meat 1000 at a desired angle.

Although not shown in FIG. 1, each of the multiple joints 121, 122, 123, 124, 125 may include a shaft that rotates around a predefined rotational axis. The deboning robot 100 is controlled to move along a candidate path defined on the target meat 1000 based on the results of the rotational movements of the multiple joints 121, 122, 123, 124, 125. The specific structures enabling each of the joints 121, 122, 123, 124, 125 to perform rotational movements are obvious to those skilled in the art, so a detailed description will be omitted.

Each of the joints 121, 122, 123, 124, 125 may include sensors to measure the torque opposing the angle at which the cutting part 110 is inserted into a cross-section of the target meat. Although not shown in FIG. 1, the position control device of the deboning robot can modify the candidate path by comparing the magnitude of the force (i.e., reaction force) opposing the angle at which the cutting part 110 is inserted into a cross-section of the target meat with a predefined threshold. The process by which the position control device of the deboning robot modifies the candidate path will be further described with additional drawings.

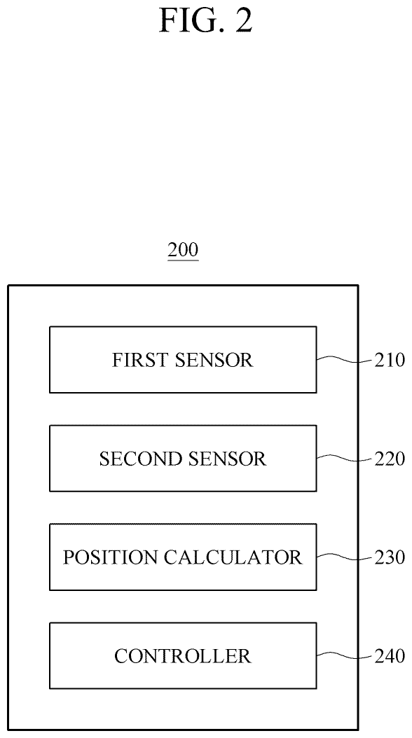

FIG. 2 is a block diagram for explaining the position control device of the deboning robot. Referring to FIG. 2, the position control device 200 of the deboning robot may include a first sensor 210, a second sensor 220, a position calculator 230, and a controller 240. The first sensor 210 is located at the front of the deboning robot and can acquire image data including the target meat and the front end of the deboning robot. As an example, the first sensor 210 can be implemented as an RGB camera for acquiring image data. Additionally, as another embodiment, the first sensor 210 can be implemented as an RGB-D camera that acquires depth information along with RGB color data of the target meat. More specifically, the first sensor 210 can acquire image data including the area contacted by the cutting part of the deboning robot on a cross-section of the target meat.

The second sensor 220 may be placed at each of the joints of the deboning robot. As an example, the second sensor 220 can be implemented as an inertial sensor to measure angular momentum, displacement, etc., obtained from each joint. The second sensor 220 can measure the magnitude of the force (i.e., reaction force) corresponding to the angle at which the cutting part of the deboning robot is inserted into a cross-section of the target meat based on predefined calculations. The calculation process of the second sensor 220 will be further described with subsequent drawings.

The position calculator 230 can calculate multiple position vectors based on the displacement between the position of the cutting part and the positions of each joint. More specifically, the multiple position vectors can include displacements from the positions of each joint at a specific point in time to the position of the cutting part as elements.

The controller 240 can set a candidate path corresponding to a designated part of the target meat using the acquired image data. More specifically, the controller 240 can extract landmarks set for each part of the target meat from the image data acquired by the first sensor 210. For example, the shank part of a cow, which is used in dishes like beef bone soup or seolleongtang, represents the meat attached to the forearm bone of the front leg or the tibia of the hind leg. Therefore, the controller 240 can use the upper part of the forearm bone or the lower part of the tibia as landmarks to extract the shank part from the image data acquired by the first sensor 210.

The controller 240 can set a candidate path corresponding to a specific part using a look-up table storing landmarks corresponding to each part. Exemplarily, but not limitedly, the look-up table can be implemented as follows.

TABLE 1

| Target Area | Landmarks | Candidate Path |
|---|---|---|
| Shank | Upper part of the forearm bone | Route A |
| | Upper part of the tibia | |
| Rump | Beginning of the tailbone | Route B |
| Sirloin | upper part of the thoracic | Route C |
| | vertebral ribs | |
| Ribs | Upper part of the rib | Route D |
| | Lower part of the rib | |
| . . . | . . . | . . . |

The additional details will be described with supplementary drawings.

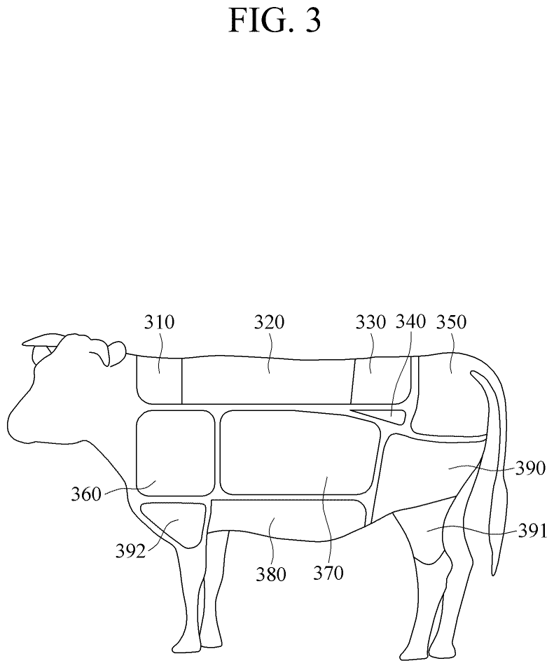

FIG. 3 is an illustrative diagram showing the candidate paths for the movement of the deboning robot, set in accordance with the divided meat parts of a cow. Referring to FIG. 3, candidate paths for various parts such as chuck 310, sirloin 320, striploin 330, tenderloin 340, rump 350, front leg 360, ribs 370, brisket 380, round 390, and different cuts of shank 391, 392 are displayed. The controller 240 can identify landmarks previously stored, corresponding to each part from the image data, and set the candidate paths for the movement of the robot's cutting part appropriate for each part.

However, the size of each part and the position of the bones can vary slightly depending on the growth conditions and breed of the cow. Therefore, there is a need to adjust the candidate paths to suit the target meat for cutting each part according to its intended use. Thus, the controller 240 can modify the candidate paths by comparing the magnitude of the force opposing the angle at which the cutting part is inserted into a cross-section of the target meat and a reaction force at 180 degrees with a predefined threshold to determine if the cutting part has contacted bone.

The process by which the deboning robot modifies the candidate paths and establishes new bypass routes will be explained with additional drawings.

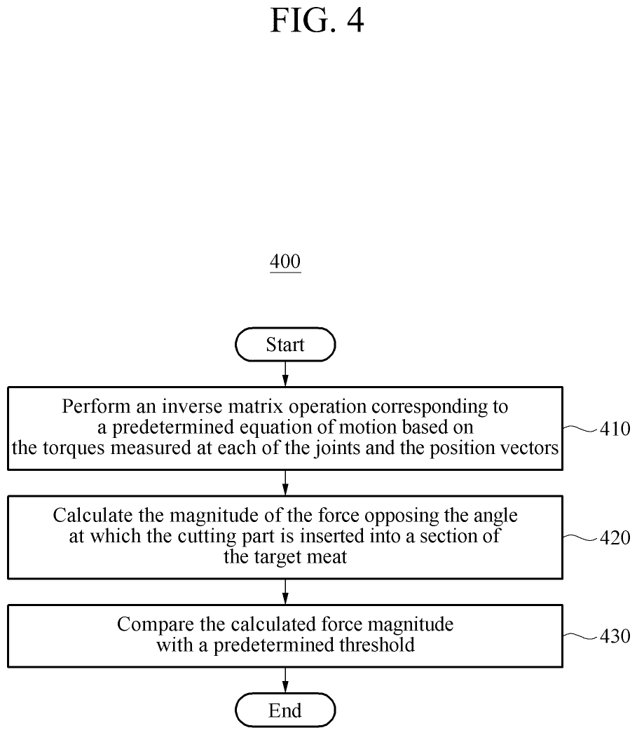

FIG. 4 is a flowchart describing the process by which the position control device of the deboning robot adjusts the candidate paths based on the reaction forces measured from the designated part of the target meat. Referring to FIG. 4, the method 400 of adjusting the candidate paths of the robot's cutting part includes steps performed by the controller included in the position control device. The method 400 involves performing calculations corresponding to a predefined motion equation based on the torques measured from each joint and the position vectors 410, calculating the magnitude of the force opposing the insertion angle into a cross-section of the target meat 420, and comparing the calculated force magnitude with a predefined threshold 430.

In step 410, the controller can receive torques (τ1, τ2, τ3, . . . , τn) measured at each

of the joints from the second sensor. Additionally, the controller can receive multiple position vectors representing the displacement between the position of the cutter of the deboning robot and the positions of each of the joints from the position calculator.

$$\frac{d}{dt} \frac{\partial L}{\partial {\dot{q}}_{i}} - \frac{\partial L}{\partial {q}_{i}} = {τ}_{i} \qquad [ EQUATION 1 ]$$

$$for i = 1 , 2 , ⋯ , n$$

The controller can calculate the Lagrangian for a deboning robot with multiple joints according to the Lagrange equations of motion defined as in Equation 1 above. In Equation 1, i is an index corresponding to each joint, and τᵢ represents the torque measured at the i-th joint. qᵢ is the displacement value corresponding to the difference between the position of the i-th joint and the position of the cutting part of the deboning robot, and \dot{q}ᵢ represents the acceleration value obtained by differentiating qᵢ with respect to time. Additionally, L denotes the Lagrangian, which is defined as the difference between the kinetic energy and potential energy of the cutting part of the deboning robot.

Furthermore, the kinetic energy T(q, \dot{q}) of the deboning robot, which includes multiple joints, is defined as shown in Equation 2 below.

$$T ( q , \dot{q} ) = \frac{1}{2} {\dot{q}}^{T} M ( q ) \dot{q} \qquad [ EQUATION 2 ]$$

In Equation 2, M(q) represents the inertia matrix of the deboning robot. By applying Equation 2 for kinetic energy to Equation 1 and rearranging, the dynamic relationship that defines the torque corresponding to each joint can be derived as shown in Equation 3 below.

$$M ( q ) \ddot{q} + C ( q , \dot{q} ) \dot{q} + g ( q ) = τ \qquad [ EQUATION 3 ]$$

In Equation 3, C(q, \dot{q}) \dot{q} represents the Coriolis vector, and g(q) represents the gravitational vector as potential energy. By using the torques and position vectors measured at each of the joints as described above, the position control device of the deboning robot can calculate the reaction force at the cutting part corresponding to the robot's end effector.

The above example explains the process of deriving Equation 3 from the Lagrange equations of motion to aid understanding, but it would be apparent to an ordinary technician that Equation 3 could also be derived from the Newton-Euler equations of motion.

In another embodiment, the position control device of the deboning robot can measure the force at the end effector through a third sensor placed at the cutting part of the robot. For example, the third sensor can be implemented as a force-torque sensor.

The controller of the position control device can perform the operation of the correlation matrix representing the internal force interaction of the joints of the deboning robot in the Lagrange equations of motion defined as in Equation 1.

At step 420, the controller of the position control device can calculate the magnitude of the force opposing the angle at which the cutting part of the deboning robot is inserted into a section of the target meat. Specifically, based on the operation performed in step 410, the controller can calculate the reaction force measured at the cutting part representing the end of the deboning robot. This reaction force may represent the magnitude of the force opposing the angle at which the cutting part (e.g., blade) of the deboning robot is inserted into a section of the target meat.

At step 430, the controller can compare the calculated force magnitude with a predetermined threshold. More specifically, the predetermined threshold can be set based on the first reaction force when the cutting part of the deboning robot is inserted into a muscle portion of the target meat, the second reaction force when inserted into a fat portion, and the third reaction force when inserted into a bone portion. To determine the bone portion of the target meat, the controller can set a range within the margin of error from the experimentally measured third reaction force as the predetermined threshold.

Accordingly, if the magnitude of the force opposing the angle at which the cutting part is inserted into a section of the target meat exceeds the predetermined threshold, the controller can determine that the contacted area is bone. In this case, the controller can establish a new bypass path corresponding to the designated area of the target meat.

In one embodiment, the controller can determine a predetermined bypass radius corresponding to the designated area of the target meat. Additionally, the controller can modify the candidate path so that the cutting part avoids the area based on the bypass radius centered around the identified position within the candidate path. More specifically, the controller can control the avoidance movement of the cutting part by inserting an additional path corresponding to a semicircle or fan-shaped arc with a radius corresponding to the bypass radius centered around the area identified as bone into the candidate path. This part is explained in more detail below with additional figures.

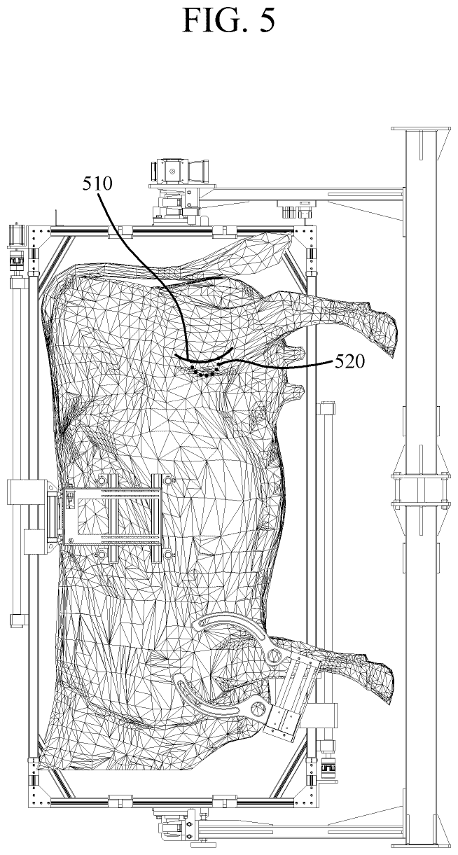

FIG. 5 is an example diagram explaining the process by which the position control device of the deboning robot performs avoidance movement according to a bypass radius. Referring to FIG. 5, a preset candidate path 510 is shown to proceed with the deboning of the shank portion. During the process of cutting the shank portion, the deboning robot may come into contact with the tibia of the cow. In this case, the position control device of the deboning robot can guide the avoidance movement of the cutting part according to the bypass radius corresponding to the cow's tibia. More specifically, the position control device of the deboning robot can guide the avoidance movement of the cutting part by modifying the candidate path 510 by inserting an additional path 520 corresponding to the bypass radius determined in response to the cow's tibia. As a result, the deboning robot can perform the deboning of the target meat by avoiding further movement along the original candidate path 510, which has a high possibility of additional contact with the bone, and instead following the additional path 520 to prevent potential damage to the cutting part due to contact with the bone.

Returning to FIG. 4, further explanation is provided regarding the process of setting the avoidance path by the controller. In another embodiment, the controller can modify the candidate path using a look-up table for the bypass radius set corresponding to the average size of the bone present in the designated area. For example, but not limited to, the look-up table can be stored and managed as shown in Table 2 below.

TABLE 2

| Target Area | Bone Type | Cone Length | Bypass Radius |
|---|---|---|---|
| Shank | Tibia | 60~70 cm | 6.5 cm |
| Rib | Rib Bone | 10~13 cm | 1.2 cm |

The type of bone that the cutting part of the deboning robot comes into contact with may vary depending on the target area. Therefore, the controller can apply the respective bypass radius based on a lookup table that is set according to the average size of the bone encountered in each target area. The controller can support the deboning of the target meat by inserting an additional path in the shape of a semicircle or a fan-shaped arc, corresponding to the size of the bypass radius set for each target area, into the candidate path.

The embodiments described above can be implemented in hardware components, software components, and/or a combination of hardware and software components. For example, the devices, methods, and components described in the embodiments can be implemented using one or more general-purpose computers or special-purpose computers, such as a processor, controller, ALU (arithmetic logic unit), digital signal processor (DSP), microcomputer, FPGA (field programmable gate array), PLU (programmable logic unit), microprocessor, or any other device capable of executing and responding to instructions. The processing device can execute an operating system (OS) and one or more software applications running on the operating system. Additionally, the processing device may access, store, manipulate, process, and generate data in response to software execution.

For ease of understanding, the processing device may be described as being used individually, but one of ordinary skill in the art will understand that the processing device can include multiple processing elements and/or multiple types of processing elements. For example, the processing device may include multiple processors or one processor and one controller. Furthermore, other processing configurations, such as a parallel processor, are also possible.

Software may include a computer program, code, instructions, or any combination thereof, and can configure or collectively command the processing device to operate as desired. Software and/or data can be embodied, permanently or temporarily, in any type of machine, component, physical device, virtual equipment, computer storage medium or device, or transmitted signal wave to be interpreted by or provide instructions or data to the processing device. Software can also be distributed across networked computer systems, stored or executed in a distributed manner. Software and data can be stored on one or more computer-readable recording media.

The methods according to the embodiments can be implemented as program instructions that can be executed through various computer means and recorded on computer-readable media. Computer-readable media may include program instructions, data files, data structures, and so on, either alone or in combination. The program instructions recorded on computer-readable media may be specifically designed and configured for the embodiments, or they may be available and used by those skilled in computer software. Examples of computer-readable recording media include magnetic media such as hard disks, floppy disks, and magnetic tape, optical media such as CD-ROMs and DVDs, magneto-optical media such as floptical disks, and hardware devices specifically configured to store and execute program instructions, such as ROM, RAM, and flash memory. Examples of program instructions include both machine code, such as that produced by a compiler, and higher-level language code that can be executed by a computer using an interpreter or the like. The aforementioned hardware devices may be configured to operate as one or more software modules to perform the operations of the embodiments, and vice versa.

Although the embodiments have been described above with reference to specific drawings, those skilled in the art will appreciate that various technical modifications and variations can be made based on the above. For example, the described techniques may be performed in an order different from the described method, and/or the components of the described systems, structures, devices, circuits, etc., may be combined or arranged in a manner different from the described method, or may be replaced or substituted by other components or equivalents, and appropriate results can still be achieved.

What is claimed is:

1. A position control device for a deboning robot, comprising:
a first sensor configured to acquire image data including an area where a cutting part of the deboning robot is in contact with a section of a target meat;
a controller configured to set a candidate path corresponding to a designated area of the target meat using the acquired image data; and
a second sensor configured to measure a magnitude of a force opposing an angle at which the cutting part of the deboning robot is inserted into a section of the target meat from each joint of the deboning robot,
wherein the controller compares the magnitude of the force opposing the angle at which the cutting part is inserted into a section of the target meat with a predetermined threshold and modifies the candidate path accordingly.

2. The position control device of claim 1, further comprising:
a position calculator configured to calculate a plurality of position vectors based on a displacement between the position of the cutting part of the deboning robot and the position of each of the joints,
wherein the second sensor is configured to calculate the magnitude of the force opposing the angle at which the cutting part is inserted into a section of the target meat by performing an operation corresponding to a predetermined equation of motion based on torques measured at each of the joints and the position vectors.

3. The position control device of claim 1, wherein:
the controller is configured to determine the contacted area as bone when the magnitude of the force opposing the angle at which the cutting part is inserted into a section of the target meat exceeds the predetermined threshold, and to newly establish a bypass path corresponding to the designated area of the target meat.

4. The position control device of claim 3, wherein:
the controller is configured to determine a preset bypass radius corresponding to the designated area of the target meat, and to modify the candidate path so that the cutting part performs an avoidance movement based on the bypass radius centered around the position determined to be bone within the candidate path.

5. The position control device of claim 4, wherein:
the controller is configured to modify the candidate path so that the cutting part performs an avoidance movement according to the bypass radius set corresponding to average size of the bone present in the designated area of the target meat.
